(19) United States
(12) Patent Application Publication
(10) Pub. No.: US 2012/0146907 A1
(43) Pub. Date: Jun. 14, 2012

(54) Input Mechanism for Multiple Consoles

(75) Inventor: Thomas Viju, Hesston, KS (US)

(73) Assignee: AGCO CORPORATION, Duluth, GA (US)

(21) Appl. No.: 13/313,107

(22) Filed: Dec. 7, 2011

Related U.S. Application Data
(60) Provisional application No. 61/420,420, filed on Dec. 7, 2010.

(51) Int. Cl. G09G 5/08

(52) U.S. Cl. 345/161; 345/157

(57) ABSTRACT

A locking input may be received. In response to the received locking input, a first input device may be configured to navigate a first cursor only within a first display. Then an unlocking input may be received. In response to the received unlocking input, the first input device may be reconfigured to navigate the first cursor both within the first display and within a second display.

### RELATED APPLICATION

Under provisions of 35 U.S.C. §119(e), Applicants claim the benefit of U.S. Provisional Application No. 61/420,420 filed Dec. 7, 2010, which is incorporated herein by reference.

### BACKGROUND

In computing, a cursor is an indicator used to show the position on a computer monitor or other display device that will respond to input from a text input or pointing device. A flashing text cursor may be referred to as a caret in some cases. A mouse cursor may be referred to as a mouse pointer, owing to its arrow shape on some systems.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A locking input may be received. In response to the received locking input, a first input device may be configured to navigate a first cursor only within a first display. Then an unlocking input may be received. In response to the received unlocking input, the first input device may be reconfigured to navigate the first cursor both within the first display and within a second display.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a block diagram of a controller processor;

FIG. 3 is a flow chart of a method for providing an input mechanism;

FIG. 4 is a diagram illustrating an operating environment;

FIG. 5 is a diagram illustrating an operating environment;

FIG. 6 is a diagram illustrating an operating environment; and

FIG. 7 is a diagram illustrating an operating environment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Consistent with embodiments of the invention, an input mechanism may be provided. A user may navigate between two or more consoles (e.g. displays) and lock a cursor that will then restrict the user to use only the selected console. If the user is savvy enough to navigate multiple console menu browsing, the user may choose to unlock a cursor button switch enabling the user to browse multiple consoles with one cursor.

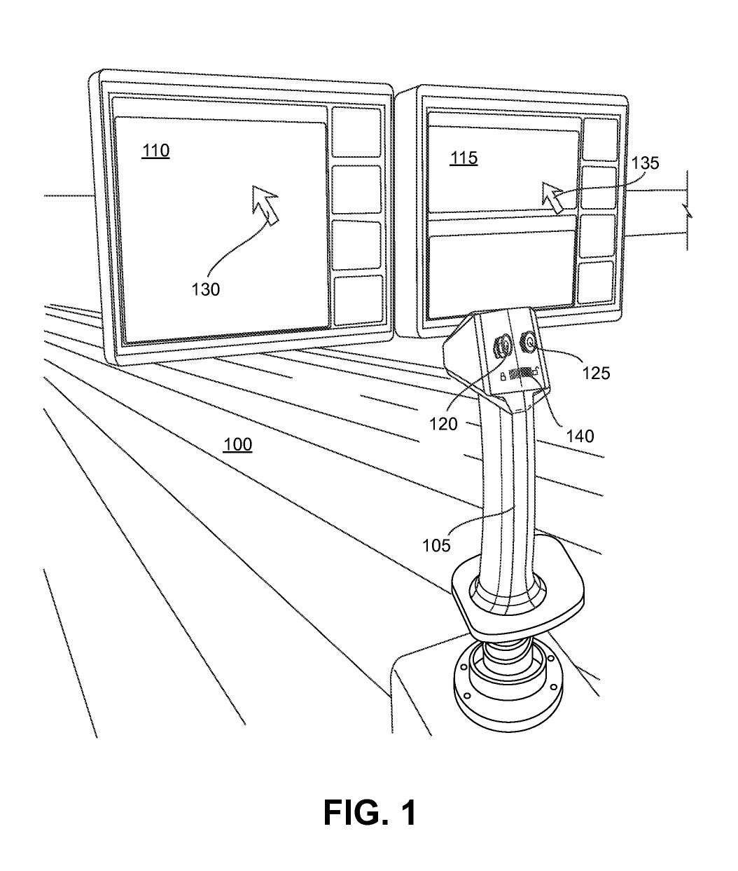

FIG. 1 is a block diagram of an operating environment 100. As shown in FIG. 1, operating environment 100 may include a joy stick 105, a first display 110, and a second display 115. Joy stick 105 may include a first input device 120 (e.g. a first thumb stick), a second input device 125 (e.g. a second thumb stick), and a cursor button switch 140. First input device 120 and second input device 125 may control a first cursor 130 and a second cursor 135 respectively. As will be described in greater detail below, cursor button switch 140 may be manipulated to “lock” first cursor 130 within first display 110 or “unlock” first cursor 130 to allow first input device 120 to navigate first cursor 130 both within first display 110 and within second display 115. Similarly, cursor button switch 140 may be manipulated to “lock” second cursor 135 within second display 115 or “unlock” second cursor 135 to allow second input device 125 to navigate second cursor 135 both within first display 110 and within second display 115.

While FIG. 1 shows first input device 120, second input device 125, and cursor button switch 140 disposed on joy stick 105, embodiments of the invention are not so limited. For example, first input device 120, second input device 125, and cursor button switch 140 may be disposed on an arm rest of a vehicle. The vehicle may comprise a truck, an automobile, a vehicle used in agriculture, or any type vehicle.

Joy stick 105 may be used in the navigation of a vehicle. First display 110 may display a first user interface for controlling a first system within the vehicle. Similarly, second display 115 may display a second user interface for controlling a second system within the vehicle.

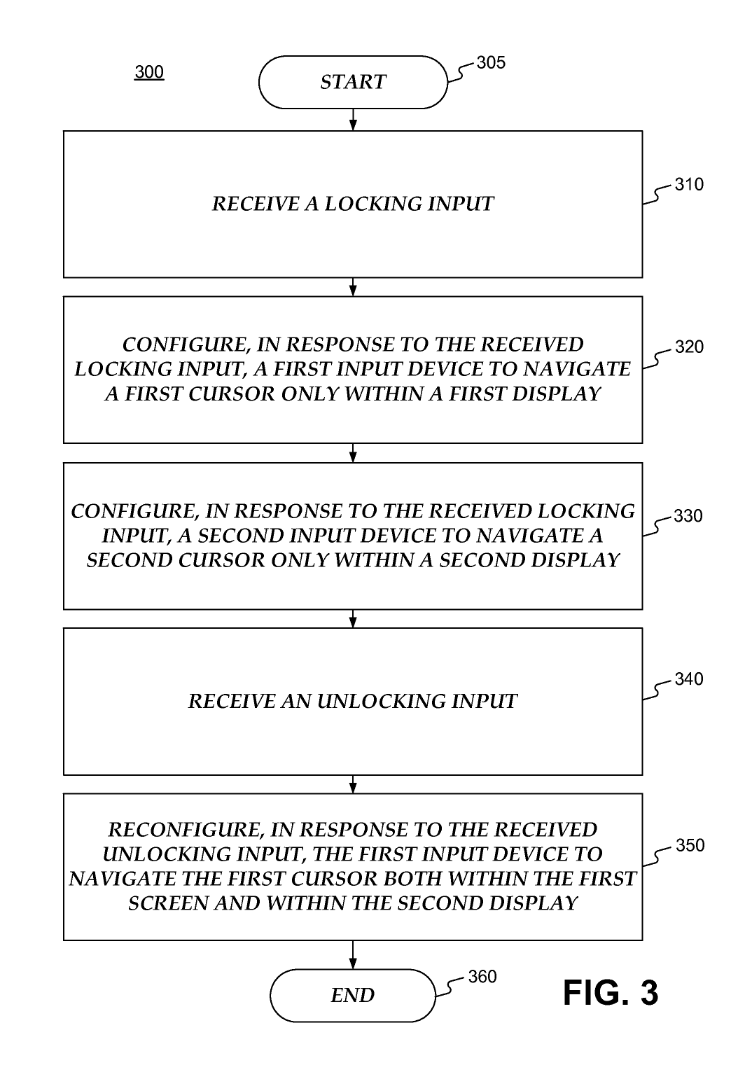

Embodiments consistent with the invention may comprise a system for providing an input mechanism. The system may comprise a memory storage for maintaining a database and a processing unit coupled to the memory storage. The processing unit may be operative to carry out one or more of method 300 stages' as described below with respect to FIG. 3.

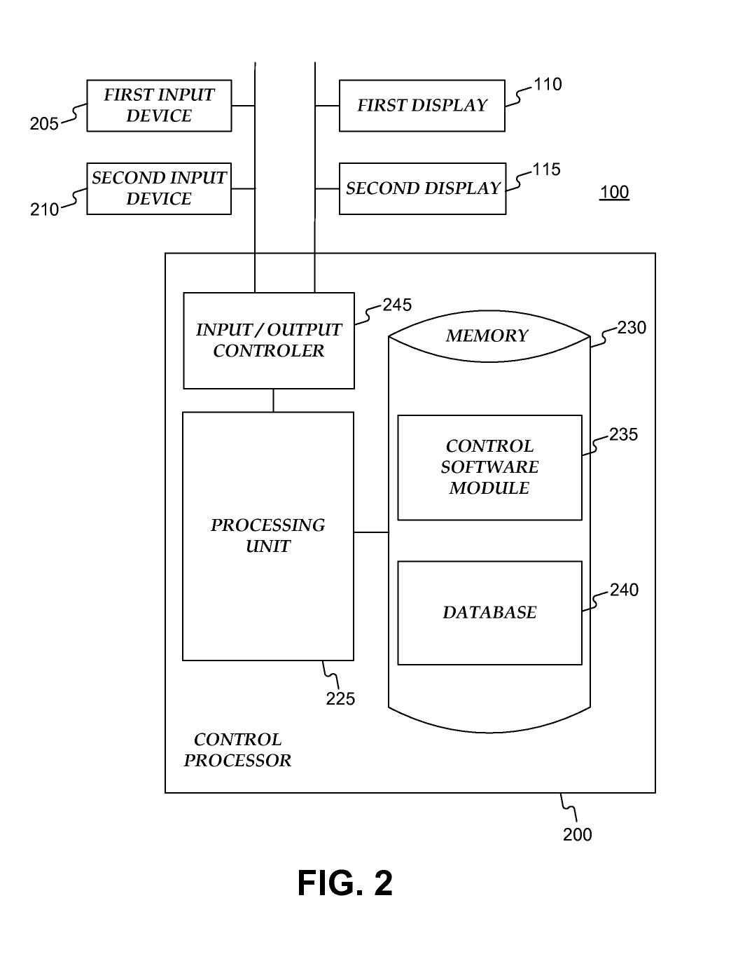

Consistent with embodiments of the present invention, the aforementioned memory, processing unit, and other components may be implemented in a computer processor, such as a control processor 200 of FIG. 2. Any suitable combination of hardware, software, and/or firmware may be used to implement the memory, processing unit, or other components.

FIG. 2 shows operating environment 100 of FIG. 1 in more detail. As shown in FIG. 2, operating environment 100 may include control processor 200, first display 110, second display 115, first input device 120, and second input device 125. Control processor 200 may include a processing unit 225 and a memory 230. Memory 230 may include a control software module 235 and a database 240. Control processor 200 may further include an input/output controller 245 configured to interface processing unit 225 with input and out put devices (e.g. first display 110, second display 115, first input device 120, and second input device 125.) While executing on processing unit 225, control software module 235 may perform processes for providing an input mechanism, including, for example, one or more of method 300 stages' as described below with respect to FIG. 3.

Control processor 200 (“the processor”) may be implemented using a personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processors may comprise other systems or devices.

FIG. 3 is a flow chart setting forth the general stages involved in a method 300 consistent with an embodiment of the invention for providing an input mechanism. Method 300 may be implemented using a controller processor 200 as described in more detail above with respect to FIG. 2. Ways to implement the stages of method 300 will be described in greater detail below.

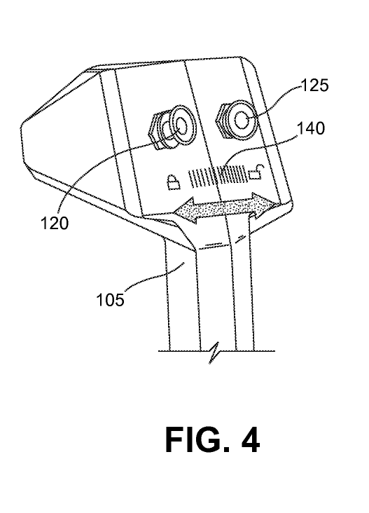

Method 300 may begin at starting block 305 and proceed to stage 310 where controller processor 200 may receive a locking input. For example, the locking input may be received by controller processor 200 in response to a user sliding cursor button switch 140 from an “unlocked” position to a “locked” position. As shown in FIG. 4, cursor button switch 140 may slide to the right to be placed in an unlocked position or cursor button switch 140 may slide to the left to be placed in the locked position.

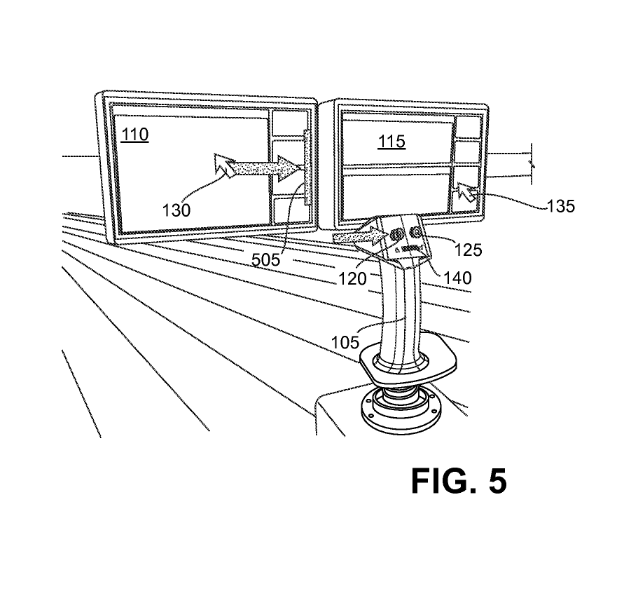

From stage 310, where controller processor 200 receives the locking input, method 300 may advance to stage 320 where controller processor 200 may configure, in response to the received locking input, first input device 120 to navigate first cursor 130 only within first display 110. As shown in FIG. 5, in response to the received locking input, first cursor 130 may only be allowed to navigate within first display 110 in response to the user manipulating first input device 120. In other words, first cursor 130 may only be allowed to navigate to the edges of first display 110 in response to first input device 120. For example, first cursor 130 may only be allowed to navigate to an edge 505 of first display 110 and stop. The user my be holding first input device 120 toward the right, however, first cursor 130 may stop when it gets to edge 505 of first display 110.

Once controller processor 200 configures first input device 120 in stage 320, method 300 may continue to stage 330 where controller processor 200 may configure, in response to the received locking input, second input device 125 to navigate second cursor 135 only within second display 115. As shown in FIG. 5, in response to the received locking input, second cursor 135 may only be allowed to navigate within second display 115 in response to the user manipulating second input device 125. For example, like the above example in stage 320, second cursor 135 may only be allowed to navigate to the edges of second display 115 and stop.

After controller processor 200 configures second input device 125 in stage 330, method 300 may proceed to stage 340 where controller processor 200 may receive an unlocking input. For example, the unlocking input may be received by controller processor 200 in response to the user sliding cursor button switch 140 from the “locked” position to the “unlocked” position. As shown in FIG. 4, cursor button switch 140 may slide to the right to be placed in an unlocked position or cursor button switch 140 may slide to the left to be placed in the locked position.

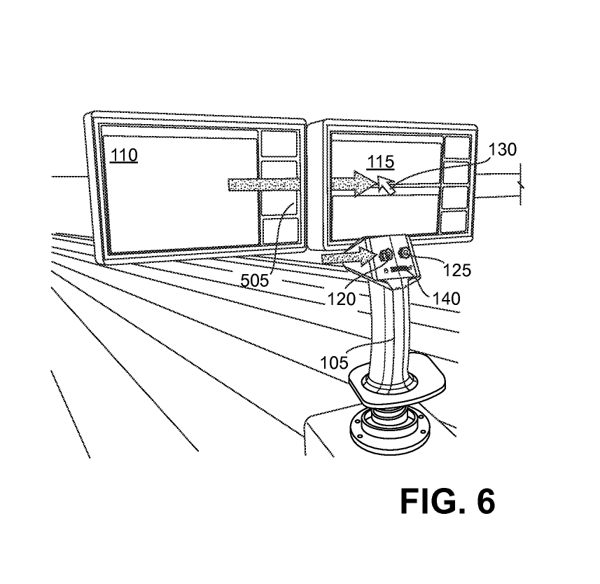

From stage 340, where controller processor 200 receives the unlocking input, method 300 may advance to stage 350 where controller processor 200 may reconfigure, in response to the received unlocking input, first input device 120 to navigate first cursor 130 both within first display 110 and within second display 115. As shown in FIG. 6, in response to the received unlocking input, first cursor 130 may not only be allowed to navigate within first display 110, but also within second display 115 in response to the user manipulating first input device 120. In other words, first cursor 130 may be allowed to navigate past one or more of the edges of first display 110 in response to first input device 120. For example, unlike the example above in stage 320, first cursor 130 may not be restricted by edge 505 and may be allowed to navigate past edge 505 of first display 110 and into second display 115. In other words, the user my be holding first input device 120 toward the right and first cursor 130 may be allowed to navigate past edge 505 of first display 110 and into second display 115 as shown in FIG. 6. Any one or more of the stages of method 300 may be repeated to “lock” first cursor 130 and second cursor 135, “unlock” first cursor 130 and second cursor 135, and “relock” first cursor 130 and second cursor 135. Once controller processor 200 reconfigures first input device 120 in stage 350, method 300 may then end at stage 360.

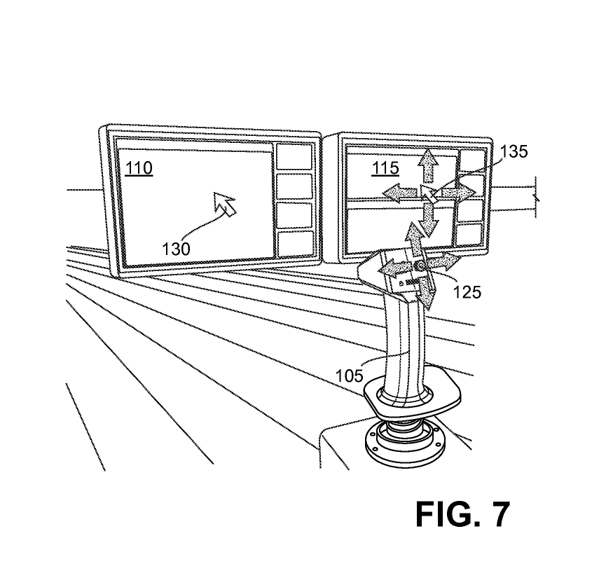

In another embodiment, as shown in FIG. 7, joy stick 105 may include only one input device (e.g. a thumb stick) along with a cursor button switch. The input device may control a cursor. In this embodiment, the cursor button switch may be manipulated to “lock” the cursor within first display 110 or “lock” the cursor within second display 115. When the cursor button switch is “unlocked”, control processor may allow the input device to navigate the cursor between both first display 110 and second display 115. When the cursor button switch is “locked”, control processor may limit the input device to navigate the cursor within whichever display (e.g. first display 110 or second display 115) the cursor was in when the cursor button was switched to “locked”.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as show in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While certain embodiments of the invention have been described, other embodiments may exist. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing an input mechanism, the method comprising:
receiving a locking input;
configuring, in response to the received locking input, a first input device to navigate a first cursor only within a first display;
receiving an unlocking input; and
reconfiguring, in response to the received unlocking input, the first input device to navigate the first cursor both within the first display and within a second display.

2. The method of claim 1, further comprising configuring, in response to the received locking input, a second input device to navigate a second cursor only within the second display.

3. The method of claim 2, further comprising:
receiving a relocking input; and
reconfiguring, in response to the received relocking input, the first input device to navigate the first cursor only within the first display.

4. The method of claim 3, further comprising reconfiguring, in response to the received relocking input, the second input device to navigate the second cursor only within the second display.

5. The method of claim 1, wherein configuring the first input device comprises configuring the first input device being disposed within a vehicle.

6. The method of claim 1, wherein configuring the first input device comprises configuring the first input device being disposed within an arm rest within a vehicle.

7. The method of claim 1, wherein configuring the first input device comprises configuring the first input device being disposed on a joy stick.

8. The method of claim 1, wherein configuring the first input device comprises configuring the first input device comprising a thumb stick being disposed on a joy stick.

9. The method of claim 1, wherein configuring the first input device comprises configuring the first input device being disposed on a joy stick used to navigate a vehicle.

10. The method of claim 1, wherein receiving the locking input comprising detecting a first movement of a switch disposed on a joystick.

11. The method of claim 10, wherein receiving the unlocking input comprising detecting a second movement of the switch disposed on the joystick.

12. The method of claim 1, wherein configuring the first input device comprises configuring the first input device disposed within a vehicle wherein the first display displays a first user interface for controlling a first system in the vehicle.

13. The method of claim 1, wherein configuring the first input device comprises configuring the first input device disposed within a vehicle wherein the first display displays a first user interface for controlling a first system in the vehicle and wherein the second display displays a second user interface for controlling a second system in the vehicle.

14. The method of claim 1, wherein configuring the first input device comprises configuring the first input device disposed within a vehicle wherein the first display displays a first user interface for controlling a first system in the vehicle and wherein the second display displays a second user interface for controlling a second system in the vehicle, the first input device being disposed on a joy stick having a trigger used to select elements from the first user interface and the second user interface.

15. A computer-readable medium that stores a set of instructions which when executed perform a method for providing an input mechanism, the method executed by the set of instructions comprising:
receiving a locking input;
configuring, in response to the received locking input, one of the following;
an input device to navigate a cursor only within a first display when the cursor is within the first display prior to receiving the locking input, and
the input device to navigate the cursor only within a second display when the cursor is within the second display prior to receiving the locking input;
receiving an unlocking input; and
reconfiguring, in response to the received unlocking input, the input device to navigate the first cursor both within the first display and within a second display.

16. The computer-readable medium of claim 15, wherein configuring the input device comprises configuring the input device being disposed within a vehicle.

17. The computer-readable medium of claim 15, wherein configuring the input device comprises configuring the input device being disposed on a joy stick used to navigate a vehicle.

18. The computer-readable medium of claim 15, wherein receiving the locking input comprising detecting a first movement of a switch disposed on a joystick.

19. The computer-readable medium of claim 18, wherein receiving the unlocking input comprising detecting a second movement of the switch disposed on the joystick.

20. A system for providing an input mechanism, the system comprising:
a memory storage; and
a processing unit coupled to the memory storage, wherein the processing unit is operative to:
receive a locking input comprising the processing unit being operative to detect a first movement of a switch disposed on a joystick;
configure, in response to the received locking input, a first input device to navigate a first cursor only within a first display, the first input device comprising a first thumb stick disposed on the joystick;
configure, in response to the received locking input, a second input device to navigate a second cursor only within a second display, the second input device comprising a second thumb stick disposed on the joystick;
receive an unlocking input comprising the processing unit being operative to detect a second movement of the switch; and
reconfigure, in response to the received unlocking input, the first input device to navigate the first cursor both within the first display and within the second display wherein the first display displays a first user interface for controlling a first system in the vehicle and wherein the second display displays a second user interface for controlling a second system in the vehicle, the joy stick having a trigger used to select elements from the first user interface and the second user interface.
